(19) United States
(12) Patent Application Publication
(10) Pub. No.: US 2002/0150193 A1
(43) Pub. Date: Oct. 17, 2002

(54) Compact high flux neutron generator

(76) Inventors: Ka-Ngo Leung, Hercules, CA (US); Jerome Maurice Verbeke, Sunnyvale, CA (US)

Correspondence Address: LAWRENCE BERKELEY NATIONAL LABORATORY, ONE CYCLOTRON ROAD, MAIL STOP 90B, UNIVERSITY OF CALIFORNIA, BERKELEY, CA, 94720, US

(21) Appl. No.: 10/100,956

(22) Filed: Mar. 18, 2002

Related U.S. Application Data
(60) Provisional application No. 60/276,668, filed on Mar. 16, 2001.

(51) Int. Cl. G21B 1/00; G21J 1/00

(52) U.S. Cl. 376/108

(57) ABSTRACT

A compact neutron generator has an ion source with a multi-hole spherical extraction system and a curved magnetic filter. A deuterium ion (or deuterium and tritium ion) plasma is produced by RF excitation in a plasma ion generator using an RF antenna. The multi-hole spherical extraction system of the ion source has three electrodes—plasma electrode, extraction electrode, suppressor electrode—which are used to expand a high current ion beam in a short distance. A large area spherical neutron generating target is positioned to receive the expanded ion beam from the ion generator. The extraction system and neutron generating target may alternatively be implemented with a cylindrical geometry instead of spherical, with slots instead of holes.

### RELATED APPLICATIONS

This application claims priority of Provisional Application Ser. No. 60/276,668 filed Mar. 16, 2001.

### GOVERNMENT RIGHTS

The United States Government has rights in this invention pursuant to Contract No. DE-AC03-76SF00098 between the United States Department of Energy and the University of California.

### BACKGROUND OF THE INVENTION

The invention relates to neutron tubes or sources, and more particularly to neutron tubes or sources based on plasma ion generators, including compact neutron tubes or sources which generate a relatively high neutron flux using the D-D reaction.

Conventional neutron tubes employ a Penning ion source and a single gap extractor. The target is a deuterium or tritium chemical embedded in a molybdenum or tungsten substrate. Neutron yield is limited by the ion source performance and beam size. The production of neutrons is limited by the beam current and power deposition on the target. In the conventional neutron tube, the extraction aperture and the target are limited to small areas, and so is the neutron output flux.

Commercial neutron tubes have used the impact of deuterium on tritium (D-T) for neutron production. The deuterium-on-deuterium (D-D) reaction, with a cross section for production a hundred times lower, has not been able to provide the necessary neutron flux. It would be highly desirable and advantageous to make high flux D-D neutron sources feasible. This will greatly increase the lifetime of the neutron generator, which is unsatisfactory at present. For field applications, it would greatly reduce transport and operational safety concerns. For applications such as mine detection, where thermal neutrons are presently used, the use of the lower energy D-D neutrons (2.45 MeV rather than 14.1 MeV) also would decrease the size of the neutron moderator.

Accordingly it is desirable to produce a compact neutron source with a high flux, particularly sources which generate neutrons using the D-D reaction.

### SUMMARY OF THE INVENTION

The invention is a compact neutron generator having an ion source with a multi-hole spherical extraction system and a curved magnetic filter. A deuterium ion (or deuterium and tritium ion) plasma is produced by RF excitation in a plasma ion generator using an RF antenna. The multi-hole spherical extraction system of the ion source has three electrodes—plasma electrode, extraction electrode, suppressor electrode—which are used to expand a high current ion beam in a short distance. The spherical shapes of the plasma and extraction electrodes are such that the ion beams passing through them are focused close to the suppressor electrode, cross over, and expand on the other side of the suppressor electrode. A large area spherical neutron generating target is positioned to receive the expanded ion beam from the ion generator. A spherically curved magnetic filter inside the ion source produces a uniform plasma density over the entire extraction area to ensure good ion beam extraction.

Alternatively, the extraction system and neutron generating target may be implemented with a cylindrical geometry instead of spherical.

This invention provides a neutron generator with high neutron production and compact size. Because of the increased target area, the much safer D-D reaction can be used, eliminating any tritium from the source.

### BRIEF DESCRIPTION OF THE DRAWINGS

FIG. 1 is a cross sectional view of a compact high flux neutron generator of the invention.

FIGS. 2, 3 are more detailed views of the extraction/acceleration system of the neutron generator of the invention.

### DETAILED DESCRIPTION OF THE INVENTION

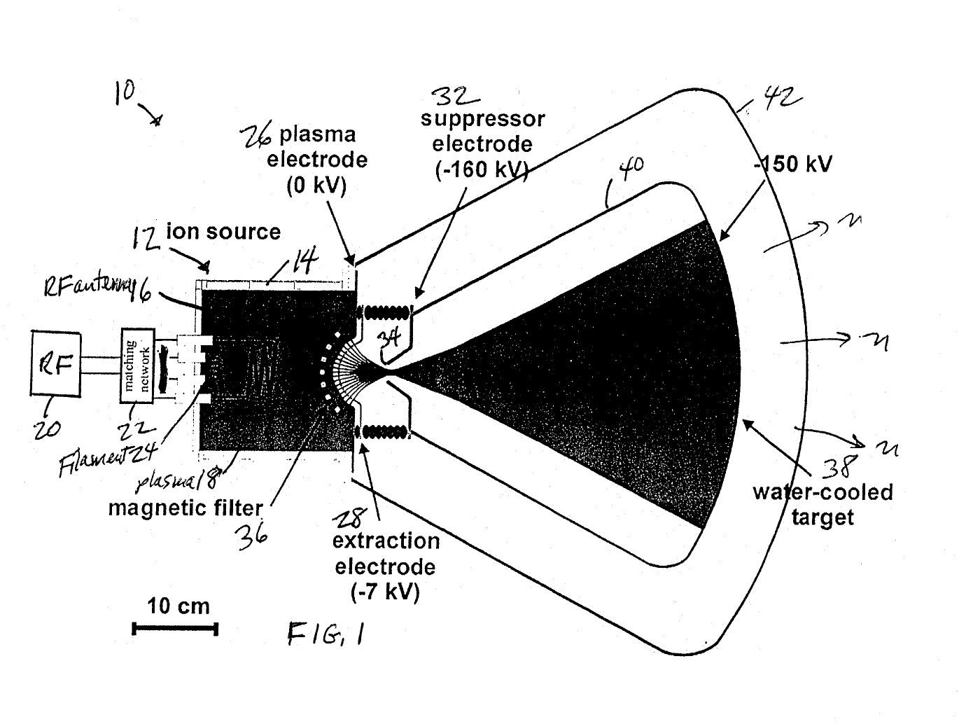

As shown in FIG. 1, compact high flux neutron generator 10 has a plasma ion source or generator 12, which typically is formed of a cylindrical shaped chamber. The principles of plasma ion sources are well known in the art. Preferably, ion source 12 is a magnetic cusp plasma ion source. Permanent magnets 14 are arranged in a spaced apart relationship, running longitudinally along plasma ion generator 12, to from a magnetic cusp plasma ion source. The principles of magnetic cusp plasma ion sources are well known in the art. Conventional multicusp ion sources are illustrated by U.S. Pat. Nos. 4,793,961; 4,447,732; 5,198,677; 6,094,012, which are herein incorporated by reference.

Ion source 12 includes an RF antenna (induction coil) 16 for producing an ion plasma 18 from a gas which is introduced into ion source 12. RF antenna 16 is connected to RF power supply 20 through matching network 22. Ion source 12 may also include a filament 24 for startup. For neutron generation the plasma is preferably a deuterium ion plasma but may also be a deuterium and tritium plasma.

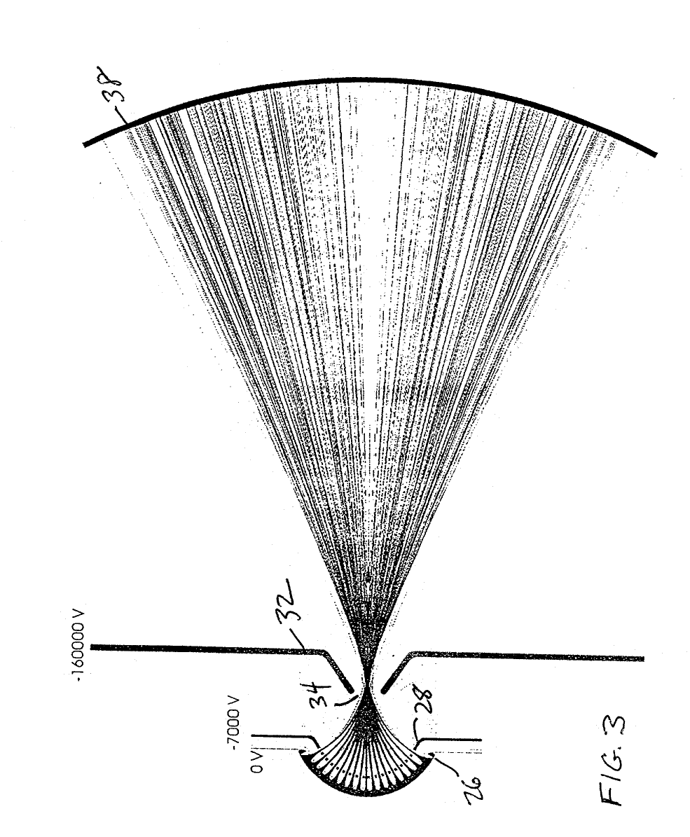

Ion source 12 also includes a pair of spaced electrodes, plasma electrode 26 and extraction electrode 28, at one end thereof. Electrodes 26, 28 electrostatically control the passage of ions from plasma 18 out of ion source 12. Electrodes 26, 28 are substantially spherical or curved in shape (e.g. they are a portion of a sphere, e.g. a hemisphere) and contain many aligned holes 30 (shown in FIG. 3) over their surfaces so that ions radiate out of ion source 12. Suitable extraction voltages are applied to electrodes 26, 28, e.g. plasma electrode 26 is at 0 kV and extraction electrode 28 is at −7 kV, so that positive ions are extracted from ion source 12.

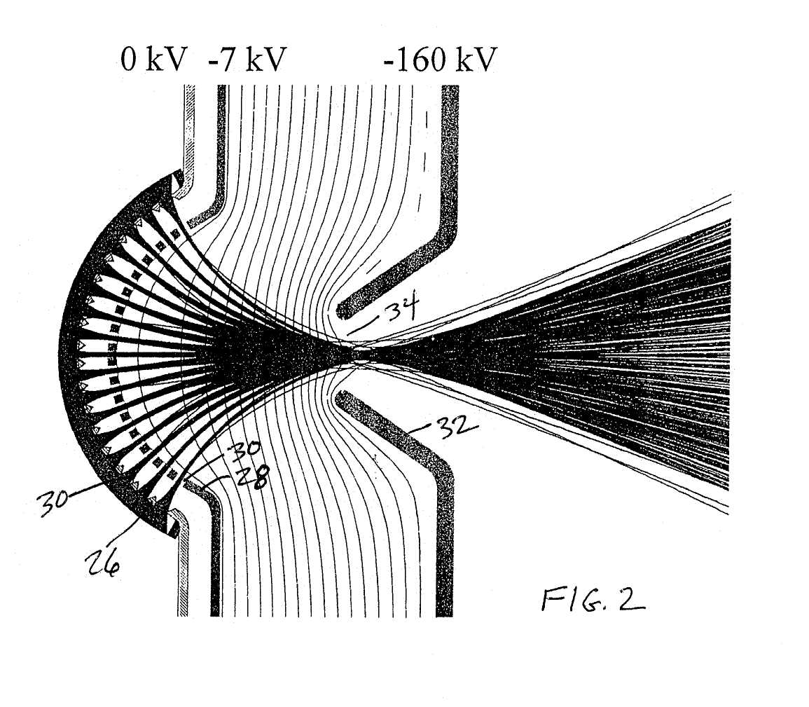

The extraction system of ion source 12 includes a third electrode, suppressor electrode 32 which contains a central aperture 34 therein. Suppressor electrode 32 is at a relatively high negative voltage, e.g. −160 kV, to accelerate the extracted ion beam. The three electrode extraction/accelerator system is used to expand a high current ion beam in a relatively short distance. The spherical shapes of the plasma and extraction electrodes 26, 28 are such that the ion beams (or beamlets) passing through all the holes 30 in electrodes 26, 28 are focused close to the suppressor electrode 32, pass through aperture 34, cross over, and expand or diverge on the other side of suppressor electrode 32. The diverging beam expands to a large area in a relatively short distance. Details of the extraction and acceleration system are shown in FIGS. 2, 3.

The plasma density on the ion source side of the plasma electrode 26 must be uniform over the entire extraction area to ensure good ion beam extraction. Plasma uniformity is obtained by positioning a spherically curved magnetic filter 36 inside ion source 12 in front of plasma electrode 26.

A spherically curved target 38 is positioned so that the expanding ion beam from ion source 12 passing through electrodes 26, 28, 32 is incident thereon. Target 38 forms a portion of a spherical surface of relatively large area at a relatively short distance from ion source 12. Target 38 is the neutron generating element, and may be water cooled. Target 38 is at a positive voltage relative to the suppressor electrode 32, e.g. at −150 kV.

Ions from plasma source 12 pass through holes 30 in electrodes 26, 28, and through aperture 34 in electrode 32, and impinge on target 38, typically with energy of 120 keV to 150 keV, producing neutrons as the result of ion induced reactions. The target 38 is loaded with D (or D/T) atoms by the beam. Titanium is not required, but is preferred for target 38 since it improves the absorption of these atoms. Target 38 may be a titanium shell or a titanium coating on another chamber wall 40, e.g. a quartz tube.

Ion source 12 is positioned at one end of a sealed tube 42, which also contains suppressor electrode 32, and neutron generating target 38, to form neutron generator 10. The entire neutron generator is very compact, e.g. about 30 cm in length.

Because of the relatively large target area of target 38, and the high ion current from ion source 12, neutron flux can be generated from D-D reactions in this neutron generator as well as from D-T reactions as in a conventional neutron tube, eliminating the need for radioactive tritium. The neutrons produced, 2.45 MeV for D-D or 14.1 MeV for D-T, will go out from the end of tube 42.

The neutron generator of the invention has a unique combination of high neutron production and compact size. The small size of the neutron generator is due mainly to the configuration of the extraction system, which allows one to extract a large ion beam current from a small ion source and to expand it onto a large area target. The large ion beam current is necessary for the high neutron output, because the neutron output is directly proportional to the ion beam current striking the target. The large area ion beam at the target is required to decrease the ion beam power density on the target, which would otherwise overheat the target and reduce neutron production. Compactness and high neutron output are achieved with the innovative extraction system and magnetic filter design.

While the invention has been described with respect to a spherical geometry, an alternate embodiment can be implemented with a cylindrical geometry, i.e. electrodes 26, 28 are cylindrical in shape (i.e. portions of cylinders), with aligned slots 30; suppressor electrode 32 is cylindrical, with central slot 34; and target 38 is cylindrical. The ion beam then focuses down to a line and expands to impinge on the target.

Changes and modifications in the specifically described embodiments can be carried out without departing from the scope of the invention which is intended to be limited only by the scope of the appended claims.

1. A neutron generator, comprising:
a plasma ion source;
a curved extraction and acceleration system at one end of the ion source;
a curved neutron generating target spaced apart from the ion source so that ions extracted from the ion source impinge on the target.

2. The neutron generator of claim 1 wherein the plasma ion source is a multicusp plasma ion source.

3. The neutron generator of claim 1 further comprising:
a RF antenna disposed within the ion source.

4. The neutron generator of claim 3 further comprising:
a matching network connected to the RF antenna; and
a RF power supply connected to the matching network.

5. The neutron generator of claim 1 wherein the curved extraction and acceleration system and the curved target are shaped as portions of spheres.

6. The neutron generator of claim 5 wherein the extraction and acceleration system comprises:
a plasma electrode; and
an extraction electrode spaced apart from the plasma electrode;
the plasma and extraction electrodes containing a plurality of aligned holes and the extraction electrode being biased relative to the plasma electrode for extracting a plurality of ion beamlets, and the plasma and extraction electrodes being curved to focus the plurality of extracted ion beamlets.

7. The neutron generator of claim 6 wherein the extraction and acceleration system further comprises:
a suppressor electrode spaced apart from the extraction electrode and having a central aperture positioned near the focus of the extracted ion beamlets, the suppressor electrode being biased with respect to the extraction electrode so that the plurality of focused extracted ion beamlets are accelerated and expanded towards the target.

8. The neutron generator of claim 7 wherein the ion beamlets are expanded to a relatively large area on the target in a relatively short distance between the suppressor electrode and the target.

9. The neutron generator of claim 1 wherein the plasma ion source is a deuterium ion source or a deuterium and tritium ion source.

10. The neutron generator of claim 1 wherein the target has a titanium surface.

11. The neutron generator of claim 1 wherein the target is water cooled.

12. The neutron generator of claim 1 further comprising a curved magnetic filter positioned inside the ion source in front of the plasma electrode.

13. The neutron generator of claim 1 further comprising a sealed tube connected to the extraction end of the ion source and enclosing the suppressor electrode and target.

14. The neutron generator of claim 13 wherein the length of the neutron generator is about 30 cm.

15. The neutron generator of claim 1 wherein the curved extraction and acceleration system and the curved target are shaped as portions of cylinders.

16. The neutron generator of claim 15 wherein the extraction and acceleration system comprises:
a plasma electrode; and
an extraction electrode spaced apart from the plasma electrode;
the plasma and extraction electrodes containing a plurality of aligned slots and the extraction electrode being biased relative to the plasma electrode for extracting a plurality of ion beamlets, and the plasma and extraction electrodes being curved to focus the plurality of extracted ion beamlets.

17. The neutron generator of claim 16 wherein the extraction and acceleration system further comprises:
a suppressor electrode spaced apart from the extraction electrode and having a central slot positioned near the focus of the extracted ion beamlets, the suppressor electrode being biased with respect to the extraction electrode so that the plurality of focused extracted ion beamlets are accelerated and expanded towards the target.
